(19) United States
(12) Patent Application Publication
(10) Pub. No.: US 2008/0086680 A1
(43) Pub. Date: Apr. 10, 2008

(54) Techniques of document annotation according to subsequent citation

(76) Inventor: Christopher Vance Beckman, New York, NY (US)

Correspondence Address: Christopher V. Beckman, 310 W. 73rd Street, Apt. 1A, New York, NY, 10023, US

(21) Appl. No.: 11/807,736

(22) Filed: May 29, 2007

Related U.S. Application Data
(60) Provisional application No. 60/808,814, filed on May 27, 2006.

(51) Int. Cl. G06F 15/00

(52) U.S. Cl. 715/230

(57) ABSTRACT

A method for presenting expressed principles of a first document according to the impact of subsequent commentary is provided. Principles of the first document that subsequent documents agree with are presented in a common, recognizable manner, such as highlighting. Principles of the first document that subsequent documents disagree with are presented in a different common, recognizable manner, such as another type if highlighting. Associated labels variably appear when the user indicates interest in a particular principle of the first document, and explain the affect of subsequent commentary on that particular principle with hyperlinks to the subject subsequent document, and provide a ranking score for the importance of the subsequent commentary. A separate indicia indicates a ranking of the validity of the first document, based on the ranking and number of subsequent commentary that agrees with and disagrees with the principles in the first document.

### CROSS-REFERENCE TO RELATED APPLICATION

This application claims the benefit of U.S. Provisional Application No. 60/808,814, filed May 27, 2006.

### TECHNICAL FIELD

The present invention relates to the organization and presentation of information within and related to documents according to commentary and other subsequent events relating to such information within previous versions of those documents.

### BACKGROUND OF THE INVENTION

In various fields of study, including the law and major sciences, documents authored at one point in time are subsequently discussed by any number of other researchers and commentators. The content of such discussions may have a substantial impact upon the validity of the subject matter expressed in the document, and the authoritative weight ascribed to that content. For example, a judicial opinion may be subsequently overruled by a more recent judicial opinion by a higher court than the first opinion. Traditionally, a person interested in the current validity of such a document may read a large volume of subsequent documents in the same field of study in an effort to analyze the current validity of that first document. Such a person may review indexes or bibliographies of related documents in an attempt to capture the universe of documents potentially impacting the validity of the first document.

More recently, citation methods have been developed, such as Shepard's® citations, which present lists of subsequent citations to a document. In addition, such lists often organize subsequent citations according to the perceived general impact of the subsequent discussion upon the validity of the document. For example, Shepard's® citations organize such lists of citations according to whether subsequent documents “follow” the reasoning of the first document, or “criticize” or “explain” it. Such a list may also include references to pages of subsequent documents where commentary on the first document may be found. The subsequent document itself may also reference pages of the first document containing subject matter upon which it is commenting.

Documents in a field of study often cover numerous topics and subtopics, and present several principles. Subsequent commentary typically concerns certain, but not all, principles expressed in the first document, and the impact of the subsequent commentary upon the first document may be limited accordingly. The subsequent commentary itself may also reference pages of the first document containing subject matter upon which it is commenting. A person viewing a document or lists of citations developed in the prior art cannot, however, readily view which principles in the first document are unaffected by subsequent commentary, which sections are affected by that commentary and which subsequent commentary impacts a particular principle in the first document. Rather, scholars reviewing documents concerning any field of study continue to engage in a labor-intensive method of reading and analyzing voluminous subsequent commentary in its entirety to determine the status of all aspects of the subject matter contained in prior documents.

Thus, improved methods of document presentation are required to address the above-described limitations in the prior art.

### SUMMARY OF THE INVENTION

The present invention is a method of presenting expressed principles of a document according to the impact of subsequent commentary. In the preferred embodiment, written clauses expressing principles that subsequent commentary has disagreed with are highlighted in red, whereas clauses expressing principles that subsequent commentary has agreed with are highlighted in green, and clauses that are not impacted by subsequent commentary are highlighted in a third color, such as light blue, or are left unhighlighted. A label is associated with each such clause, or similarly-impacted group of clauses, that explains the relevance, citation and exact location of the subsequent commentary. The associated label may variably appear when the user of the invention indicates further interest in the significance of a clause. For example, the user may “hover” a cursor on a computer screen displaying the document according to the present invention, and an informational window (also called a “bubble”) may present itself next to the clause in question (also referred to as “popping up”) on the screen, and contain the information of the associated label. The associated label may also contain “hyperlinks” to the exact location of the subsequent commentary. The associated label may express a ranking score of the importance of the subsequent commentary, based on the degree of impact that the commentary may have on the principle. The document may contain a separate indicia indicating an overall ranking of the validity or importance of the document as a whole based on the impact of subsequent commentary. For example, the number of positive references could be multiplied by coefficients reflecting their relative affect on the overall importance of the document as perceived by those skilled in the art to which the document pertains. The resulting product could be divided by the number of negative references multiplied by coefficients reflecting their relative affect on the overall importance of the document as perceived by those skilled in the art to which the document pertains. The resulting ratio could be compared to ratios developed by the same methodology with respect to other documents concerning the same field, and each could be relatively ranked according to one another by those resulting scores. It is also within the scope of this invention to accomplish the ends of the present invention in a printed, rather than electronic, format, but the associated labels would be fixed, preferably placed in the margin of the document, to the extent possible.

These and other objects and advantages of the present invention will become apparent upon further review of the following drawings and specification.

### BRIEF DESCRIPTION OF THE DRAWINGS

The novel features of the described embodiments are specifically set forth in the appended claims; however, embodiments relating to the structure and process of making the present invention may best be understood with reference to the following description and accompanying drawings.

FIG. 1 is a diagram illustrating an exemplary methodology for presenting expressed principles of a document according to the impact of subsequent commentary, according to an embodiment of the present invention.

FIG. 2 is a diagram illustrating another embodiment of the present invention with a computer screen cursor positioned to indicate interest in a particular proposition of a document that has been negatively affected by subsequent commentary, and a reacting informational window presented on the computer screen.

FIG. 3 is a diagram of another embodiment of the present invention with a computer screen cursor positioned to indicate interest in another particular proposition of the document of FIG. 2 that has been positively affected by subsequent commentary, and another reacting informational window presented on the computer screen.

Similar reference characters denote corresponding features consistently throughout the attached drawings.

### DETAILED DESCRIPTION OF THE INVENTION AND DRAWINGS

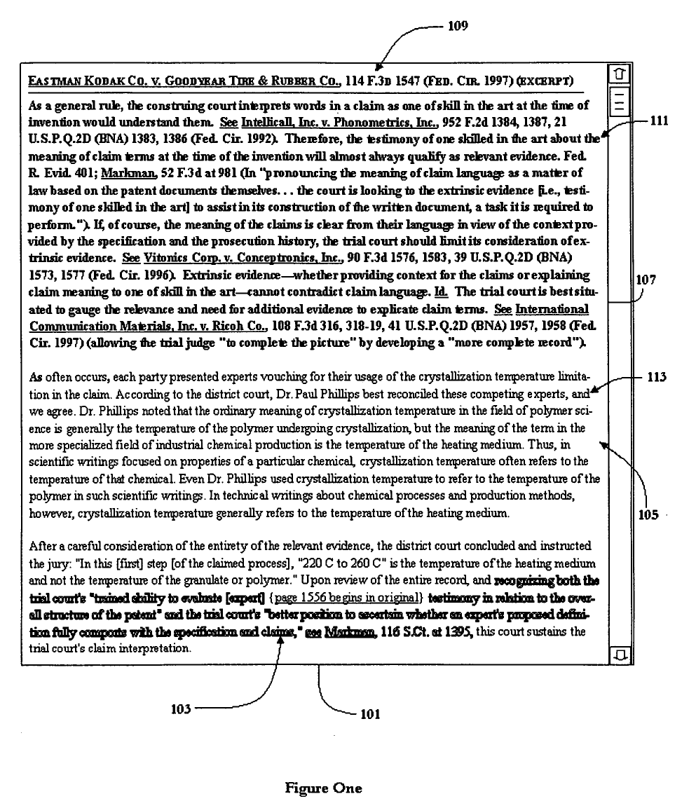

The present invention may be more fully described with reference to FIGS. 1-3. FIG. 1 illustrates exemplary methodology 101 for presenting expressed principles of a document, such as principle 103 which appears as the sentence clause: “recognizing both the trial court's ‘trained ability to evaluate [expert] {page 1556 begins in original} testimony in relation to the overall structure of the patent’ and the trial court's ‘better position to ascertain whether an expert's proposed definition fully comports with the specification and claims,’ see Markman, 116 S.Ct. at 1395.” Exemplary methodology 101 presents an excerpt of a document that may be viewable at one time 105, as on a page of the document that is viewable at one time within a computer-presented window 107 on a computer screen. The excerpt of the document 105 contains information from part of a publicly-available record of the judicial branch of the United States, which may be located according to well-known research methods according to the legal citation 109. Principle 103 was subjected to subsequent commentary from a United States court with jurisdiction to overrule the legal validity and force of principle 103. Specifically, principle 103 was overruled by the United States Court of Appeals for the Federal Circuit in Cybor Corp. v. FAS Tech.s, 138 F.3d 1448 (1998), at page 1456. Said principle 103 is presented in an outlined, transparent font to immediately indicate to the viewer that it has been negatively impacted by subsequent commentary. Another principle 111, includes the clause: “the testimony of one skilled in the art about the meaning of claim terms at the time of the invention will almost always qualify as relevant evidence . . . ” Unlike principle 103, principle 111 has been specifically upheld by a United States court with jurisdiction over the court authoring principle 111. The Court of Appeals for the Federal Circuit KopyKake Enterprises v. Lucks Company, 264 F.3d 1377, at page 1383 (2001) stated that principle 111 is the prevailing law. Accordingly, principle 111 is presented in a different font than principle 103 and the remainder of the excerpt of the document viewable at one time 105, to indicate its positive treatment by subsequent commentary. Finally, principle 113 has not been the subject of commentary either positively or negatively impacting its validity. Accordingly, principle 113 is presented in an ordinary font, different from the font of both principle 111 and principle 103 to readily indicate to a viewer the status of proposition 113 as unaffected by subsequent commentary. Due to constraints in this application to present drawings in black and white, another preferred variation on this invention has not been shown, which would include highlighting the surrounding space of propositions 103, 111 and 113, in different colors indicating the status of each proposition respectively. It is within the scope of this invention that any aesthetic indicator, with a defining key explaining the significance of said aesthetic indicators, available to the user may be used. An aesthetic indicator is any means for altering the appearance of a principle or its nearby or surrounding space to indicate the impact of subsequent commentary.

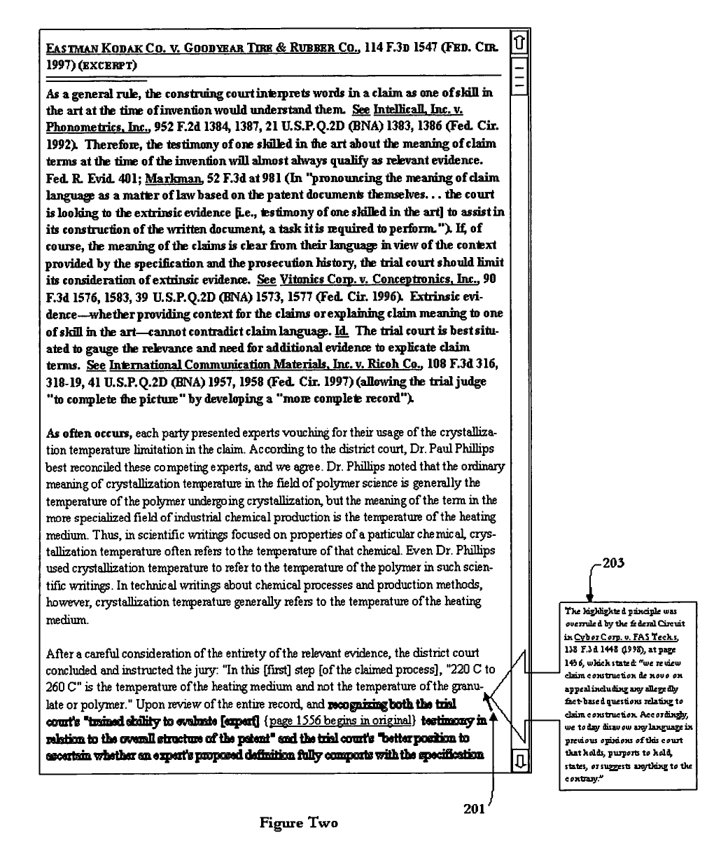

FIG. 2 is a diagram illustrating another embodiment of the present invention with a computer screen cursor 201 positioned to indicate interest in a particular proposition of a document that has been negatively affected by subsequent commentary, as discussed in FIG. 1, and a reacting informational window 203 presented on the computer screen. The reacting informational window 203 explains the significance of subsequent commentary negatively impacting said proposition. Although the preferred embodiment is of a computer-delivered, user attention-reacting informational window, it is within the scope of this invention that an informational window explaining the impact of subsequent commentary may be in a fixed medium.

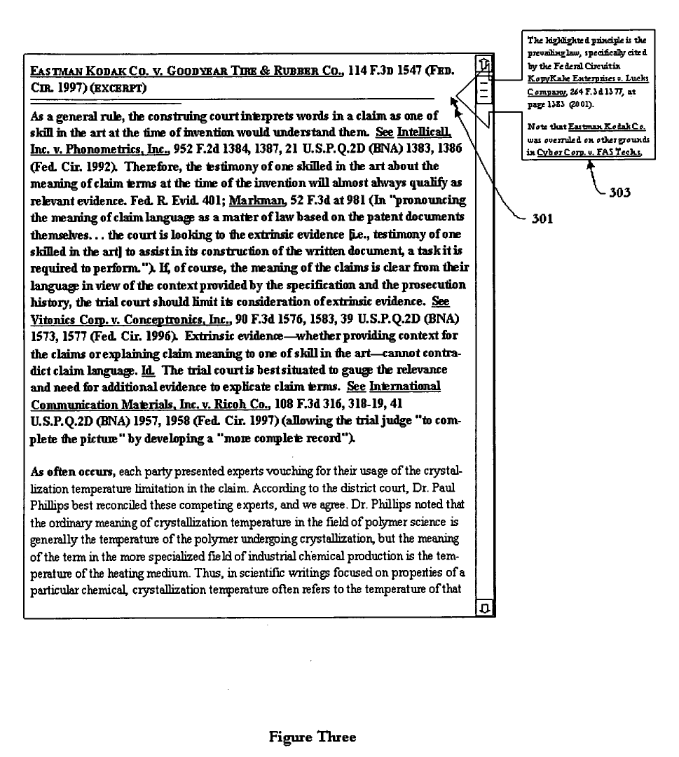

FIG. 3 is a diagram of another embodiment of the present invention with a computer screen cursor 301 positioned to indicate interest in another particular proposition of the document of FIG. 1 and FIG. 2 that has been positively affected by subsequent commentary, and another reacting informational window 303 presented on the computer screen. Reacting informational window 303 indicates the positive impact of subsequent, authoritative commentary upon said another proposition, as discussed earlier in this specification.

I claim:

1. A method for presenting principles within a document according to the impact of subsequent commentary, comprising the following steps:
Reviewing more than one principle of said document;
Reviewing available subsequent commentary relating to said more than one principle;
Presenting said more than one principle with an aesthetic indicator relaying to a user the impact of subsequent commentary.

2. The method of claim 1, in which the aesthetic indicators comprise a group of text-highlighting colors, one color of which corresponds to principles that have been subject to negative commentary, a second color of which corresponds to principles that have been subject to positive commentary, and a third of which corresponds to principles that have not been the subject of substantial positive or negative commentary.

3. The method of claim 1, in which the aesthetic indicators comprise a set of textual fonts, one font of which corresponds to principles that have been subject to negative commentary, a second font of which corresponds to principles that have been subject to positive commentary, and a third font of which corresponds to principles that have not been the subject of substantial positive or negative commentary.

4. The method of claim 1, further comprising the step of creating a key explaining the significance of each aesthetic indicator.

5. The method of claim 1, further comprising the step of creating an informational window explaining the impact of subsequent commentary on said more than one principle.

6. The method of claim 5, further comprising the step of presenting said informational window to a user upon the user indicating interest in said more than one principle.

7. The method of claim 6, in which the user indicating interest in said more than one principle comprises hovering a cursor on or near each said principle.

8. A method for presenting principles within a document according to the impact of subsequent commentary, comprising the following steps:
Reviewing each principle of said document;
Reviewing available subsequent commentary relating to said each principle;
Presenting said each principle with an aesthetic indicator relaying to a user the impact of subsequent commentary.

9. The method of claim 8, in which the aesthetic indicators comprise a group of text-highlighting colors, one color of which corresponds to principles that have been subject to negative commentary, a second color of which corresponds to principles that have been subject to positive commentary, and a third of which corresponds to principles that have not been the subject of substantial positive or negative commentary.

10. The method of claim 8, in which the aesthetic indicators comprise a set of textual fonts, one font of which corresponds to principles that have been subject to negative commentary, a second font of which corresponds to principles that have been subject to positive commentary, and a third font of which corresponds to principles that have not been the subject of substantial positive or negative commentary.

11. The method of claim 8, further comprising the step of creating a key explaining the significance of each aesthetic indicator.

12. The method of claim 8, further comprising the step of creating an informational window explaining the impact of subsequent commentary on said each principle.

13. The method of claim 12, further comprising the step of presenting said informational window to a user upon the user indicating interest in said each principle.

14. The method of claim 13, in which the user indicating interest in said each principle comprises hovering a cursor on or near each said principle.

15. A presentation of a document comprising aesthetic indicators of the impact of subsequent commentary on more than one principle of said document.

16. The presentation of a document of claim 15, in which the aesthetic indicators comprise a group of text-highlighting colors, one color of which corresponds to principles that have been subject to negative commentary, a second color of which corresponds to principles that have been subject to positive commentary, and a third of which corresponds to principles that have not been the subject of substantial positive or negative commentary

17. The presentation of a document of claim 15, in which the aesthetic indicators comprise a set of textual fonts, one font of which corresponds to principles that have been subject to negative commentary, a second font of which corresponds to principles that have been subject to positive commentary, and a third font of which corresponds to principles that have not been the subject of substantial positive or negative commentary

18. A presentation of a document comprising aesthetic indicators of the impact of subsequent commentary on each principle of said document.

19. The presentation of a document of claim 18, in which the aesthetic indicators comprise a group of text-highlighting colors, one color of which corresponds to principles that have been subject to negative commentary, a second color of which corresponds to principles that have been subject to positive commentary, and a third of which corresponds to principles that have not been the subject of substantial positive or negative commentary.

20. The presentation of a document of claim 18, in which the aesthetic indicators comprise a set of textual fonts, one font of which corresponds to principles that have been subject to negative commentary, a second font of which corresponds to principles that have been subject to positive commentary, and a third font of which corresponds to principles that have not been the subject of substantial positive or negative commentary.

21. A method of document presentation comprising an evaluation of said document according to the number and authority of subsequent negative and positive commentary on each principle of said document.

22. A graphical user interface presenting a document in which a user may indicate interest in a particular principle of the document and the user is presented with an informational window explaining the impact of subsequent commentary on said particular principle.
